(19) United States
(12) Patent Application Publication
(10) Pub. No.: US 2007/0255795 A1
(43) Pub. Date: Nov. 1, 2007

(54) Framework and Method of Using Instant Messaging (IM) as a Search Platform

(75) Inventors: Xuejun Wang, Reading, MA (US); Wei Shi, Cambridge, MA (US)

Correspondence Address: Wei Shi, APT 402, 655 Concord Avenue, Cambridge, MA, 02138, US

(73) Assignee: SOOKOOL, INC, Cambridge, MA (US)

(21) Appl. No.: 11/737,944

(22) Filed: Apr. 20, 2007

Related U.S. Application Data
(60) Provisional application No. 60/746,028, filed on Apr. 29, 2006.

(51) Int. Cl. G06F 15/16

(52) U.S. Cl. 709/207

(57) ABSTRACT

A framework and method to integrate a Search Service in an IM environment is provided. A Search Service is represented by one or more buddies or contacts of an IM user. An IM user performs inline search by adding a buddy representing a Search Service to a new or existing IM conversation, and inputting search query as a normal IM message. The Search Service sends the search results back as a regular IM message to all parties participating in the IM conversation. A Search Service implements and runs persistently one or more IM client simulators (SEIMCS) according to the communication and application protocol of an IM system. The Search Service defines one or more universally unique identifiers (UUIDs), registers one or more IM members with the UUIDs to an IM service. It logs in the defined IM members to the IM system and publishes these IM members. The framework allows a Search Service to work with any IM service, and an IM service can support any Search Service, wherein the Search Services and the IM services are operated independently. Neither IM client software nor IM system needs to be changed. No special indicators, prefix of IM message, search button or other actions need to be defined for performing search in an IM environment.

### CROSS-REFERENCE TO RELATED APPLICATIONS

Provisional application No. 60/746,028, filed on Apr. 29, 2006

### FEDERALLY SPONSORED RESEARCH

Not Applicable

### SEQUENCE LISTING OR PROGRAM

Not Applicable

### BACKGROUND OF THE INVENTION

1. Field of the Invention

The presented invention provides a method that uses Instant Messaging (IM) service as a platform for Search Service. The method allows IM users to perform search in the IM environment and share search results among IM users in the same conversation. The method further allows the Search Engine to connect with any IM platform and to be accessible to IM users; however, the Search Engine or Search Service providers operate independently from the IM providers.

2. Description of Related Art

Instant Messaging (IM) and Search are two popular and important services on the Internet and in wireless mobile environment. IM service provides communication among users who are connecting to the Internet or the wireless communication networks. The most popular implementation of an IM platform is based upon client-server architecture, where an IM service provider runs a centralized server system and distributes client software that may be installed on user's personal computer, PDA or wireless devices such as cell phone. IM users are required to register with an IM service provider to obtain an account, and install the client software on their terminal devices. A login process with user name and password is required to authenticate the user. IM services usually support text chat, voice call, video and their combinations. Two or more IM users can participate in an IM conversation. When using IM service, a user usually chooses other user(s) from a buddy list to start a conversation. The buddy list may be categorized. Popular IM systems are but not limited to Yahoo messenger, MSN messenger, AOL instant messenger, etc.

There is another type of Instant Messaging system based on peer-to-peer technology, such as Skype. This type of IM service does not use centralized server to relay the messages. Rather, it establishes peer connections among IM users participating in an IM conversation. From user's point of view, the process of using this type of IM service is the same as that using client-server architecture.

Search Service providers, also known as Search Engines, allow users to type in the search keywords and return the search results relevant to the keywords. Search Engines may also provide other types of search interfaces such as voice interface, multimedia interface, etc.

Currently, the IM and the Search are separated services.

Recent development has put limited search capability into IM environment. MSN messenger adds a search button on side of the input box. User can type in the search key words in the input box and click the search button. The search results will appear in the regular conversation area and be visible for all parties participated in the conversation. US patent application 2005/0234883 described a technique to perform inline search in IM environment. It requires a special string to prefix search keywords in order for the IM or IM server to identify that the user wants to do search. US patent application 2005/0234885 describes another technique to allow user to search for the profile of the person in conversation by clicking a search button. For all the above applications, the Search Engine being used has to be provided or chosen by the said IM provider.

Objects and Advantages

The present invention provides a novel method to integrate Search Service with IM service. A Search Engine registers with IM service as a usual IM member and login with user name and password. The IM users add Search Engine entity to their buddy list appearing just as a regular contact. However, when an IM user starts a conversation with the buddy representing a Search Engine, the input of the IM user is sent to the Search Engine and is interpreted as search query. The search results are sent back to the same IM user and presented in his or her IM window. If the conversation involves other IM users, the search results are presented on every party's IM window. No search button or special prefix is required to indicate the search query. Neither the IM client software for IM users, nor the IM server system if used needs to be modified. Moreover, the framework allows any Search Engine to connect to any IM platform and be accessible to the users of the said IM platform; therefore the Search Engines do not depend on IM service providers, and vice versa.

### SUMMARY OF THE INVENTION

The present invention provides methods to integrate Instant Messaging (IM) service with Search Service so that the IM users can perform search within the IM environment. An IM user can start search by staring a normal IM conversation with an IM buddy which represents a Search Engine. In addition, an IM user can include a search buddy representing a Search Engine into a conversation with his or her normal IM buddies, and perform search and share the search results among the IM users in the conversation.

An IM provider needs to publish its application protocol interface (API) for the third party to develop IM client. A Search Service provider can use the API provided by the IM provider to develop a software layer, Search Engine IM Client Simulator (SEIMCS), to interface with the IM server. In the peer-to-peer case, the SEIMCS directly interfaces to the peer IM client(s) instead of IM server. The Search Engine registers one or more IM members representing the Search Service to the IM system with universally unique identifiers (UUIDs), the same way as that of the normal IM users, which is called Search Engine IM Buddy (SEIMB) in this document. A Search Engine can support multiple SEIMBs for an IM platform, and define each SEIMB a specific purpose. For example, each SEIMB represents a search category, e.g. shopping, dinning, etc.

The Search Service provider who registers SEIMB(s) to an IM service publishes the names of its SEIMB(s), similar to a normal IM user makes his or her IM name known by his or her friends. The Search Engine can do marketing through commercial advertising, word of mouth, etc. The IM users are able to add the SEIMB(s) to their buddy list. Although not required, IM users can choose to group multiple SEIMBs, for instance, group all SEIMBs from one Search Engine.

An IM user performs a standalone search by starting an IM conversation with a SEIMB. The user's input, in the formats of text, recoded voice, voice call, recorded video, image, etc, is sent as a normal IM message to the IM server, which relays the message to the SEIMCS handling the SEIMB. The IM server transfers the message exactly the same way as it handles normal IM users and messages without the knowledge of SEIMB and SEIMCS. An IM user can also perform the search in the context of an existing conversation by adding a SEIMB to the current conversation. In the peer to peer IM case, the user's IM client sends the input IM message directly to the SEIMCS handling the SEIMB.

The SEIMCS receives IM message sent by an IM user, and interprets the data as a search query. It then sends the search query to the Search Engine and receives the search results from the Search Engine. The SEIMCS may customize the search results according to the features of the IM system it interfaces with. The SEIMCS then sends the search results as an IM message back to the IM server the same way as a normal IM user. The IM server sends the search results to the user or users who involve in the context of the conversation, and the IM user's client software presents the search results as an IM message for the conversation. In the peer to peer IM case, the SEIMCS sends search results to the IM client(s) of the corresponding user or users directly.

The search results can be in the formats of text, hyperlink, image, video, audio, real-time stream or call answering, etc, as long as the user's IM client software supports the formats to be presented properly.

### BRIEF DESCRIPTION OF DRAWINGS

FIGS. 1-3 illustrate examples of IM users performing inline searches in an IM environment according to the present invention;

FIGS. 4-6 illustrate the diagrams of systems consisting of IM platforms, Search Engines and SEIMCSs that implement inline search in an IM environment according to the present invention;

FIG. 7 is a flow chart that illustrates the processes that a Search Engine implements interface (SEIMCS) to communicate with an IM platform and publish search service to IM users according to the present invention;

FIG. 8 is a flow chart that illustrates an example of an IM user adds a Search Service as a search buddy into his or her IM buddy list according to the present invention; and

FIGS. 9-11 are flow charts that illustrate processes for performing inline search in an IM environment and presenting the search results according to the embodiments of the present invention.

### DETAILED DESCRIPTION OF THE INVENTION

In the following detailed discussion of the present invention, we first introduce the user interface of using Instant Massaging (IM) to perform inline search. Then we describe the underlining operation and communication mechanism for the IM client to communicate with the Search Engine.

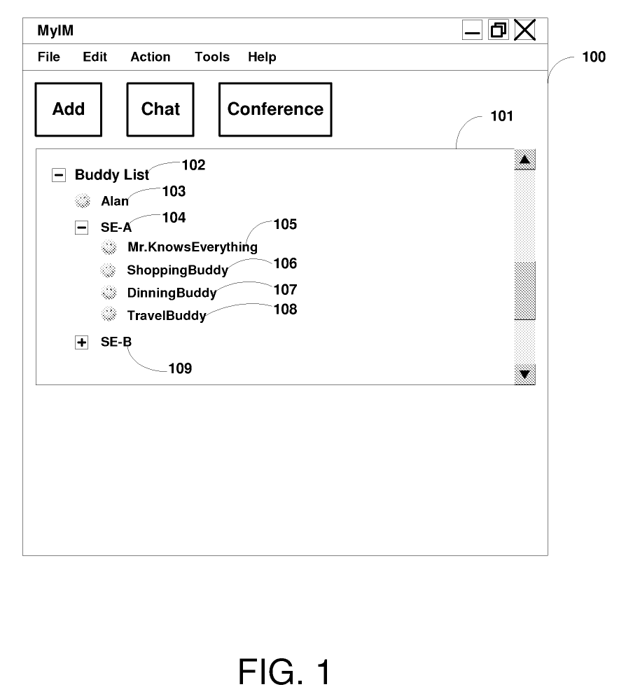

The present invention uses IM's buddy list or contact list for the placement of the Search Engine IM Buddy (SEIMB), which represents a Search Engine or a specific search category of a Search Engine. FIG. 1 illustrates a window 100 displayed by an IM client software that contains a buddy list area 101 of the IM user. Display window 100 shows an example of how the IM's buddy list can be used to represent search engine(s).

An IM user's buddy list 102 in the buddy list area 101 contains his or her regular human contacts, such as Alan 103, as well as SEIMB(s) from one or more Search Engines. A search engine publishes at least one SEIMB. The search engine may choose to publish the SEIMB(s) for all IM platforms, or publish distinguished SEIMB(s) for different IM platforms. As illustrated in Buddy List 102, the buddies Mr.KnowsEverything 105, ShoppingBuddy 106, DinningBuddy 107 and TravelBuddy 108 are SEIMBs published by Search Engine A. In this example the IM user groups the SEIMBs of Search Engine A into a buddy group SE-A 104. Each SEIMB has a universally unique identifier (UUID) so that it can be used by all IM users. For example, the UUID of a SEIMB of Search Engine A can be an email address at Search Engine A's domain, e.g. Mr.KnowsEverything@SE-A.com. Multiple Search Engines can be added to an IM user's buddy list, for example, buddy group SE-B 109 in Buddy List 102.

IM user adds a SEIMB to his or her buddy list exactly the same way as that he or she adds other human buddies. It may require but not limit for IM user to input a unique ID, usually an email address, then the IM server searches for the registered members, and if found, the IM server adds it to the IM user's buddy list. The implementation of adding a buddy may be different for peer to peer based IM, e.g. Skype. However, the Search Service provider has to register and login one or more SEIMBs as members of the IM platform(s) which it desires to service. In the example illustrated by FIG. 1, Search Engine A registers Mr.KnowsEverything, ShoppingBuddy, DinningBuddy and TravelBuddy to the IM platform.

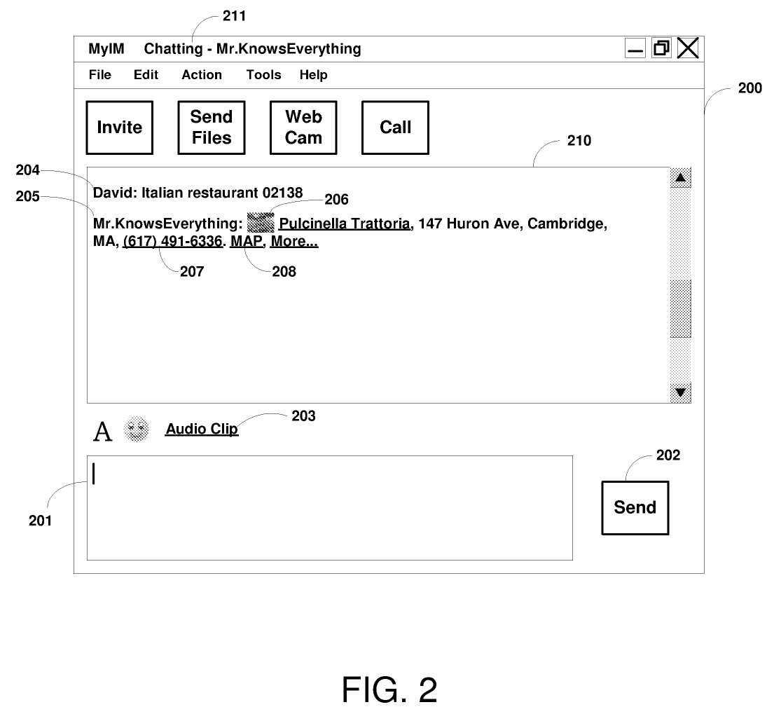

The IM user performs inline search in IM environment by starting a conversation with a SEIMB previously added in his or her buddy list representing a Search Engine. FIG. 2 illustrates a window 200 displayed by an IM client software when the IM user, David, chooses Mr.KnowsEverything 105 from his buddy list and starts a conversation. Instant messages send to and receive from other user(s) are displayed in conversation region 210 of window 200. After initiating a conversation session with a SEIMB, the IM user can perform search by entering a search query in input region 201 and then send it by clicking send button 102, hitting enter key or other means. The search query may be text based the same as search keywords of conventional Internet search. The IM user can use other multi-media means to input search queries, for example, the Audio Clip 203. There is no requirement for the IM user to indicate his or her input is a search query, such as a predefined search trigger, search button or prefix, etc.

The IM client displays IM user's inputted search query the same format as normal conversation in region 210. For example, the IM user David enters the search query “Italian restaurant 02138” 204. In one embodiment of the present invention, where the IM platform uses client-server architecture, the search query is sent by the IM client software to the IM server as a normal IM message, and the IM server replays the search query to corresponding Search Engine. In another embodiment of the present invention, where the IM service uses peer-to-peer technology, the IM client software sends the search query directly to the corresponding Search Engine.

The Search Engine represented by Mr.KnowsEverything, Search Engine A in this example, performs the required search upon receiving the search query. In a client-server implementation of the IM service, the Search Engine sends the search results to the IM server, which relays the search results to the IM client. In a peer-to-peer implementation of the IM service, the Search Engine sends the search results directly to the IM client. The IM client software presents the search results inline in the conversation region 210 just the same as a normal IM message of a conversation. The search engine can return search results in any format supported by the IM service and the IM client software, with possibly embedded image 206, hyperlinks 208, audio/video clips, real-time streaming, phone number allowing click-to-call 207, etc.

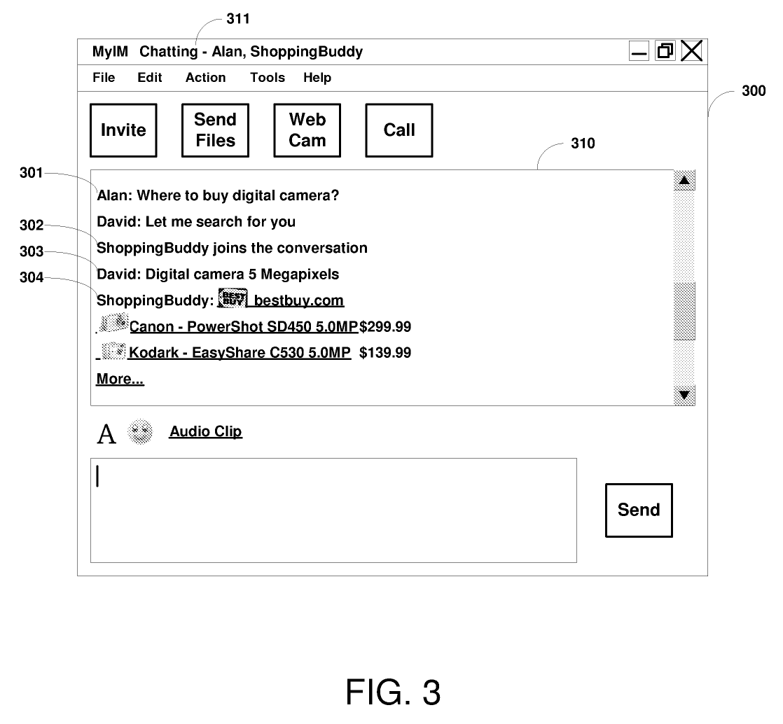

The IM user can perform an inline search within the context of a conversation with one or more other human IM user(s) and share the search result among the IM users. FIG. 3 illustrates an example of inline search within the context of an IM conversation. IM client software displays a conversation window 300 for two human IM users, Alan and David, to have a normal IM conversation. The instant messages of the conversation are displayed in conversation region 310.

In this example, IM users Alan and David are discussing shopping for digital camera 301. To perform an inline search in the conversation window 300, David adds ShoppingBuddy 106, a SEIMB of Search Engine A, to the conversation 302. David then types in the search query “Digital camera 5 Megapixels” 303. Again, the search query is the same as a normal IM message without any special indication. David's search query is displayed by the IM client software in both David's and Alan's conversation region 310. The search query is sent as an IM message to the corresponding Search Engine A via either client-server type of communication or peer-to-peer type of communication as described above. By using the categorized SEIMB ShoppingBuddy rather than generic SEIMB Mr.KnowsEverything, the Search Engine can better understand that the purpose of the search is for shopping therefore it can produce more relevant search results.

The search engine sends the search results to the IM server if the IM service uses client-server architecture. The IM server relays the search results to both David's and Alan's IM clients. For a peer-to-peer IM architecture, the search engine sends the search results directly to both Alan's and David's IM clients. Both David's and Alan's IM clients present the search results 304 in the conversation region 310, appearing as an answering IM message from the ShoppingBuddy. Including a SEIMB in the context of a conversation allows the search results to be shared by all parties of the conversation. In addition, the search results can include one or more sponsored results.

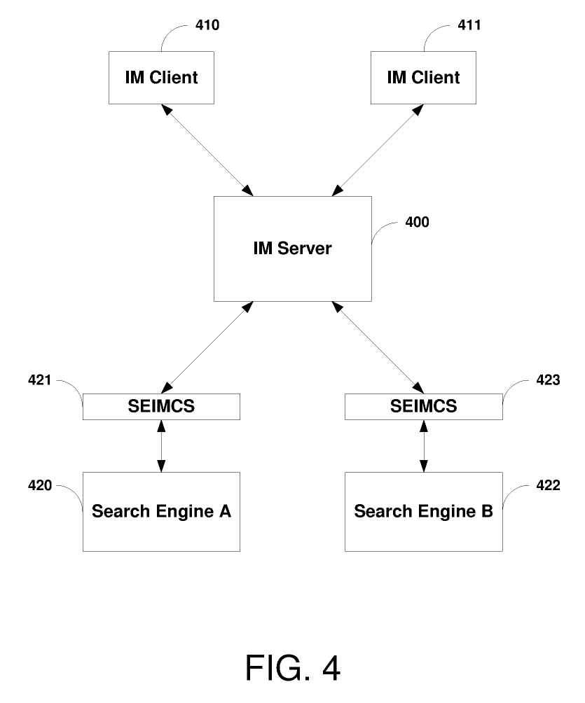

FIG. 4 illustrates an example of a system implements the embodiment of the present invention, where the IM service is implemented by client-server architecture. The system includes an IM server 400 and IM clients such as IM Client 410 and IM Client 411. Only two IM clients are shown in FIG. 4 for simplicity. In fact, IM server 400 can communicate with many more IM clients. IM clients communicate with each other through IM server 400.

Search Engine appears as one or more IM clients of the IM environment through its Search Engine IM Client Simulator (SEIMCS). In FIG. 4, Search Engine A 420 connects to the IM Sever 400 through its SEIMCS 421, while Search Engine B 422 connects to the IM Server 400 through its SEIMCS 423. The SEIMCS of a search engine should be implemented according to the communication and application protocol of the specific IM system it connects to. The SEIMCS must register one or more IM members to the IM system, usually but not limit to the unique email address at the Search Engine's domain. The SEIMCS must log in one or more of its registered IM members. The SEIMCS runs and connects to the IM server permanently. Only two Search Engines are shown in FIG. 4 for simplicity. However, any Search Engine that implements the SEIMCS according to the protocol of an IM system can be included in this framework.

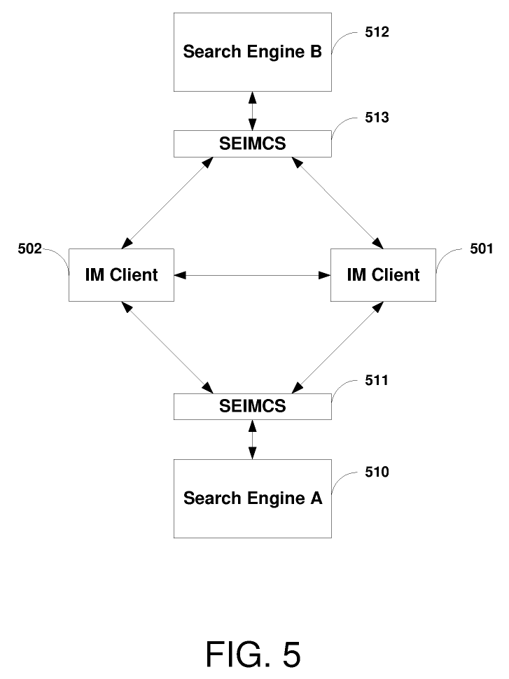

FIG. 5 illustrates another example of a system implements the embodiment of the present invention, where the IM service is implemented by using peer-to-peer technology. The system includes IM clients such as IM Client 501 and IM Client 502. Only two IM clients are shown in FIG. 5 for simplicity. In fact, multiple IM clients can communicate with each other through a peer-to-peer protocol. Search Engine again appears as one or more IM clients of the IM environment through its SEIMCS. In FIG. 5, Search Engine A 510 connects to the IM system through its SEIMCS 511, while Search Engine B 512 connects to the IM system through its SEIMCS 513. Similar to the previous discussion, the SEIMCS should be implemented according to the communication and application protocol of the specific IM system it connects to. The SEIMCS must register one or more members to the IM system, and must log in one or more of its registered IM members. The SEIMCS runs and connects to the IM system permanently. Only two Search Engines are shown in FIG. 5 for simplicity. However, any Search Engine that implements the SEIMCS according to the protocol of an IM system can be included in this framework.

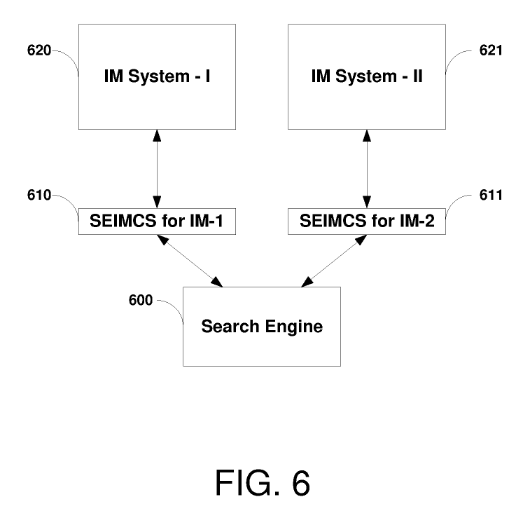

In addition, a Search Engine can serve multiple IM systems by implementing multiple SEIMCSs for corresponding IM systems. FIG. 6 illustrates an example of an implementation. A Search Engine 600 services IM System I 620 via its SEIMCS for IM-I 610, and services IM System II 621 via its SEIMCS for IM-II 611. The SEIMCS for IM-I 610 is implemented according to the communication and application protocol of IM System I 620, while the SEIMCS for IM-II 611 is implemented according to that of IM System II 621. Only two IM systems are shown in FIG. 6 for simplicity. However, a Search Engine can connect to any IM system by implementing SEIMCS according to the communication and application protocol of the specific IM system.

The advantages of the present invention are the following. First of all, it provides a consistent user interface to IM users who intend to do search in an IM environment, regardless which IM system they prefer to use. The Search Engines are represented by one or more buddies in the user's buddy list of an IM system. User performs search by simply including the Search Engine buddy, SEIMB, in a new or an existing conversation. Secondly, no IM client software needs to be changed, upgraded and distributed. There is no special search button or predefined string needed to indicate that a user's input or action is a search. Thirdly, a Search Engine is able to provide search service independently from the IM platform. A Search Engine can work with any IM system by implementing a SEIMCS to interface with the specific IM system, and registering and publishing its SEIMB(s). Lastly, there is no change needed for the IM server system to support search capability. The IM service providers simply open their communication and application protocol to the Search Service providers.

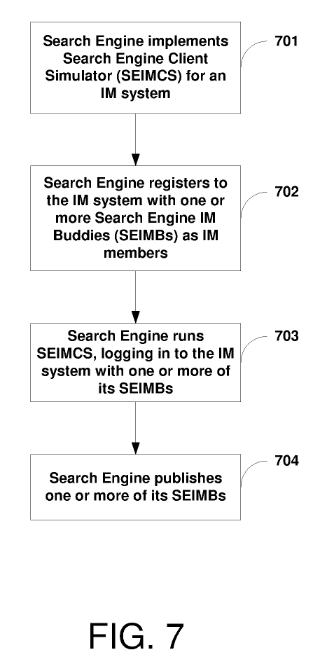

FIG. 7 is a flow chart that illustrates the process for a Search Engine to connect to an IM system and provide search service in IM environment. At step 701, a Search Engine implements a SEIMCS for an IM system according to the communication and application protocol of that IM system. At step 702, the Search Engine defines one or more SEIMBs with UUIDs, and registers the SEIMBs with the IM system as IM members. The UUIDs for SEIMBs can be but not limit to the email addresses in the Search Engine's domain. The registering process is the same as that for a normal IM user. At step 703, the Search Engine starts the SEIMCS for the said IM system. The SEIMCS communicates with the IM system and logs in the IM system with one or more of its SEIMBs according to the IM system's login protocol. The SEIMCS runs persistently. At step 704, the Search Engine publishes one or more of its SEIMBs for the said IM system in order for the IM users to add them into their buddy list and start using the search service in IM environment.

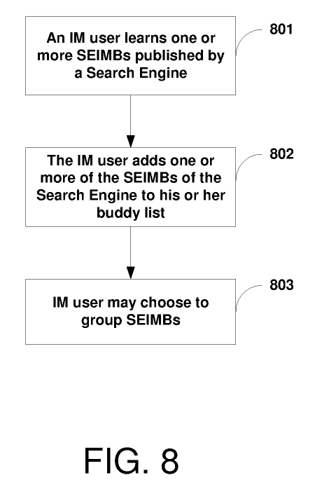

FIG. 8 is a flow chart that illustrates how an IM user may start using the Search Service in his or her IM environment. At step 801, an IM user learns one or more SEIMBs published by a specific Search Engine for the IM system he or she is using. At step 802, the IM user adds one or more SEIMBs of the Search Engine to his or her IM buddy list. At step 803, the IM user may want to group SEIMBs from the Search Engine and/or other Search Engine(s).

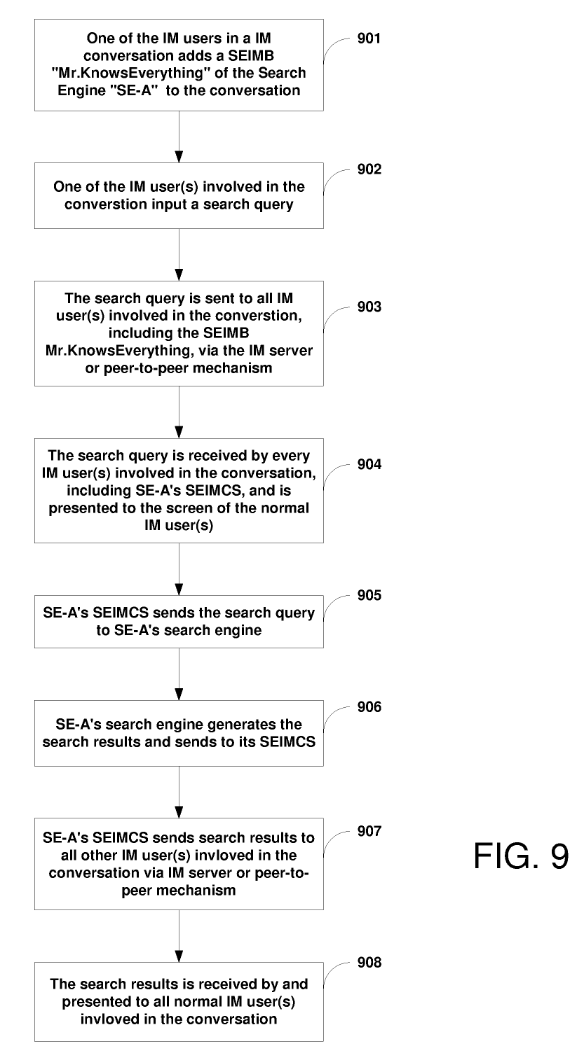

FIG. 9 is a flow chart that illustrates the process of conducting an inline search in an IM environment and displaying the search results according to an embodiment of the present invention. At step 901, in the context of any IM conversation or when a new IM conversation is started, an IM user can add one SEIMB to the conversation, for example, the Mr.KnowsEverything 105 of SE-A 104 in FIG. 1. At step 902, one of the IM user(s) involved in the conversation input a search query, for example, search keywords, as an IM message. The search query can be in many formats supported by the IM system, such as text, audio/video clip, image, and multimedia content, etc. At step 903, the search query is sent to every IM user involved in the conversation as an IM message, including the SEIMB Mr.KnowsEverything, by the IM client software, exactly the same way as any other regular IM message. The underlining communication mechanism can be client-server where the search query is sent to the IM server which relays the search query to every other IM user in the conversation, or peer-to-peer where the IM client sends the search query directly to every other IM user in the conversation. At step 904, the search query is received by every IM user involved in the conversation, including the SEIMCS of the Search Engine SE-A corresponding to the SEIMB Mr.KnowsEverything. The search query is presented by IM client software to the screens of every normal IM user, including the sender. At step 905, the SEIMCS sends the search query to the Search Engine SE-A.

At step 906, the Search Engine SE-A performs the search against the search query and generates the search results, which is sent back to the Search Engine's SEIMCS. At step 907, the SEIMCS sends the search results to every other IM user involved in the conversation. As described above, this is done via IM server if the IM system is client-server architecture, or via peer-to-peer mechanism. At step 908, the IM client of every normal IM user receives the search results and presents them to the IM user.

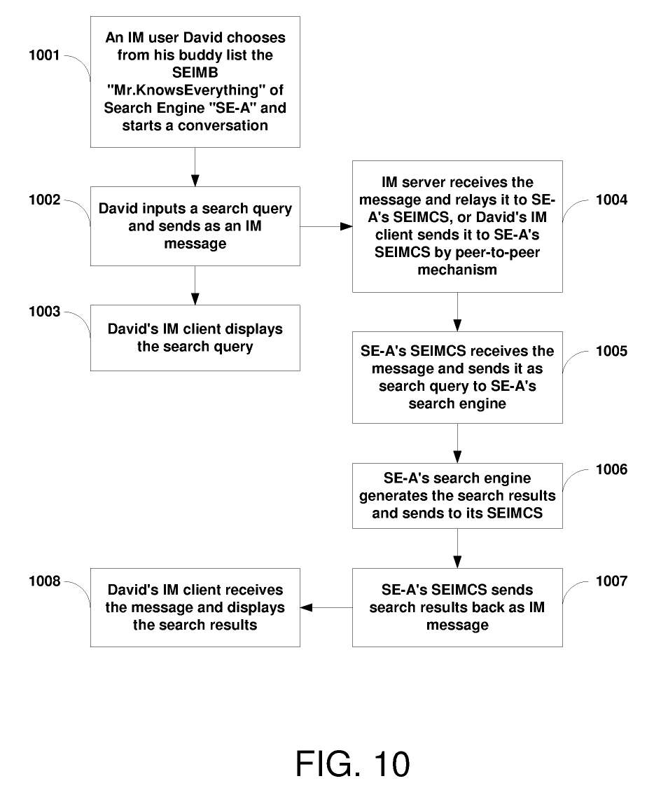

FIG. 10 is a flow chart that illustrates the process of performing a standalone inline search in an IM environment and presenting the search results according to an embodiment of the present invention. At step 1001, an IM user, David, chooses from his buddy list a SEIMB Mr.KnowsEverything of the Search Engine SE-A and starts a conversation. At step 1002, David inputs a search query and sends it as a regular IM message. At step 1003, David's IM client displays the search query in the conversation area of the IM window. At step 1004, the search query is sent to the SEIMCS of the Search Engine SE-A. If the IM system employs client-server architecture, the IM server receives the search query and relays it to the search engine. If the IM system employs peer-to-peer mechanism, David's IM client software sends the search query to the SEIMCS of the Search Engine SE-A directly. At step 1005, the SEIMCS of the Search Engine SE-A receives the search query and sends it as a search request to the Search Engine. At step 1006, the Search Engine performs the required search and sends the search results back to its SEIMCS. At step 1007, the SEIMCS of the Search Engine SE-A sends the search results back as a regular IM message. The SEIMCS may customize the search results according to the features of the IM system before sending back the search results. Similar to step 1004, the communication mechanism for the SEIMCS to send back the search results as an IM message can be either client-server method or peer-to-peer method. At step 1008, David's IM client receives the IM message containing the search results and presents it in the conversation area of the IM window.

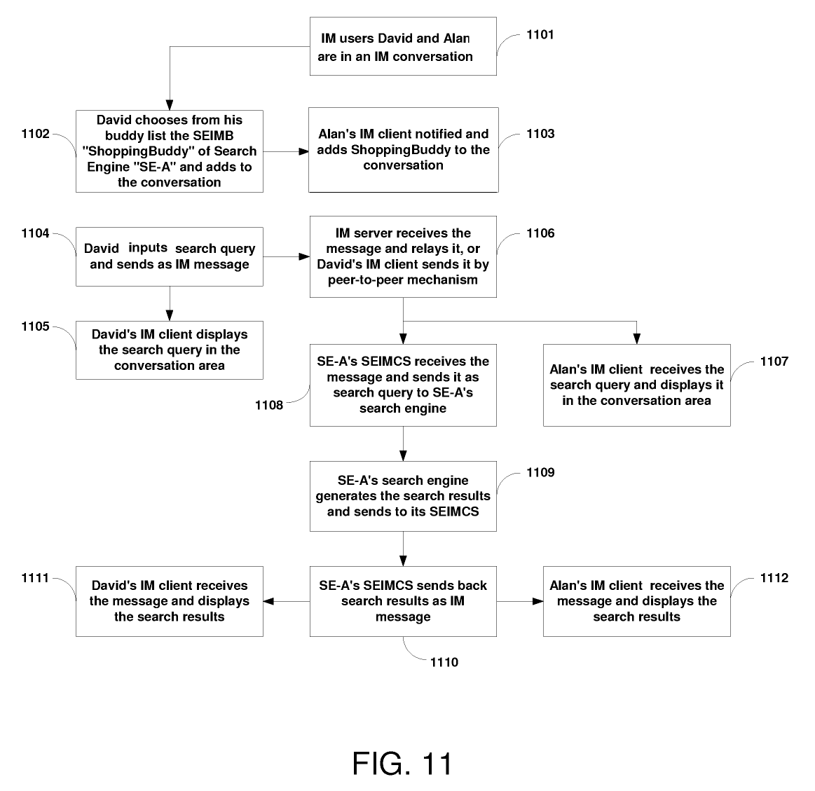

FIG. 11 is a flow chart that illustrates the process of performing an inline search in the context of a conversation with multiple IM users in an IM environment and presenting the search results according to an embodiment of the present invention. The search and results are shared by all IM users of the conversation. Only two IM users are presented in the flow chart. In fact, any number of IM users can be involved in the flow as long as the IM system supports. At step 1101, two IM users, David and Alan, are involved in an IM conversation. At step 1102, David chooses from his buddy list the SEIMB ShoppingBuddy of the Search Engine SE-A, and adds it to the current conversation. At step 1103, through regular IM process, Alan's IM client adds the ShoppingBuddy to the current conversation as well. At step 1104, David inputs a search query and sends it as a regular IM message. At step 1105, David's IM client displays the search query in the conversation area of the IM window. At step 1106, the search query is sent to all other parties of the conversation, including the SEIMCS of the Search Engine SE-A. If the IM system employs client-server architecture, the IM server receives the search query and relays it the same way as other IM messages. If the IM system employs peer-to-peer mechanism, David's IM client software sends the search query to all parties of the conversation directly. At step 1107, Alan's IM client receives the search query and displays it in the conversation area of the IM window as a normal IM message.

At step 1108, the SEIMCS of the Search Engine SE-A receives the IM message of the search query and sends it as a search request to the Search Engine. At step 1109, the Search Engine performs the search and sends the search results back to its SEIMCS. At step 1110, the SEIMCS of the search engine sends the search results back as a regular IM message to all other parties of the conversation. The SEIMCS may customize the search results according to the features of the IM system before sending back the search results. Similar to step 1106, the communication mechanism for the SEIMCS to send back the search results as an IM message can be either client-server method or peer-to-peer method. At step 1111, David's IM client receives the IM message containing the search results and presents it in the conversation area of the IM window. At step 1112, Alan's IM client receives the IM message containing the search results and presents it in the conversation area of the IM window.

Conclusion, Ramifications, and Scope

The present invention outlines a framework of performing search within an Instant Messaging (IM) environment. The Search Engine implements a SEIMCS for an IM service, and runs the SEIMCS to connect to the IM system. The Search Engine publishes its search service as one or more IM members, or SEIMBs, registers them to the IM systems and logs in the IM system with these SEIMBs. The IM users add the Search Engine SEIMBs as their buddies or contacts. An IM user then can perform a search by starting a conversation with the buddy representing the Search Engine. In addition, multiple IM users can perform search in the context of their conversation and share information by including a search buddy in the session of their conversation. The advantages of present invention are that there is no change of the IM client software and no software upgrade required for the IM users; that IM users perform search in IM environment exactly the same way as they have a normal conversation with other IM users; that there is no special indicator, prefix string, button or other extra action needed for an IM user to perform the search; that the framework is open, the Search Service providers and IM service providers operate independently; and that the Search Engine can choose to provide service to any IM system and the IM users can choose to use any Search Engine in their IM environment.

While the invention has been described with respect to specific embodiments, one skilled in the art will recognize that numerous modification are possible. The “Instant Messaging (IM)” as used herein is not limited to any particular protocol, format, delivery method, or form factor and includes message delivery systems according to any protocol that enables communication among a community of authenticated users. The IM client software is not limited to run on any particular device. The present invention applies to a variety of devices that support IM client, such as personal computer, PDA, mobile handset, cell phone, etc. The “Search Engine” as used herein is not limited to any particular Search Engine, or other recommendation, knowledge sharing or transaction systems. The invention is intended to cover all forms of services that can be provided in an IM environment where the service is identified and facilitated by the buddy list or contact list of the IM system. The described SEIMCS which implemented communication between a Search Engine and an IM system may be implemented by software or hardware. The invention is also intended to cover all forms of methods or implementations that make a service a client of an IM system, where the IM member representing the service may be registered with the IM system, logged in the IM system and published by the service provider.

What is claimed is:

1. A method for performing search in an Instant Messaging (IM) environment, the method comprising:
using the buddy list or contact list of a IM client application to identify one or more Search Services;
a Search Service appearing as one or more buddies or contacts of a regular IM user;
an IM user performs a standalone search by starting a regular IM conversation session with one of the buddies or contacts that represents a Search Services;
an IM user performs a shared search within the context of a conversation session with other IM user(s) by including one of the buddies representing a particular Search Service;
inputting regular IM message as a search query when a buddy or contact representing a Search Service presents in an IM conversation;
transmitting search query as a regular IM message to the designated Search Engine identified by the buddy or contact, wherein the Search Engine performs a search based on the search query and retrieves the search results;
transmitting the search results as a regular IM message to IM user who initiates the search; and
transmitting the search results as a regular IM message to all other IM user(s) who are in the same IM conversation session.

2. The method according to claim 1 further comprising:
a Search Engine implementing an IM client simulator (SEIMCS) for an IM system according to the communication and application protocol of that particular IM system;
registering one or more universal unique identifiers (UUIDs) as IM members representing the Search Service (SEIMB), wherein the IM members representing the Search Service (SEIMB) can be added to regular IM user's buddy list or contact list;
running the IM client simulator (SEIMCS) persistently and logging in one or more of the IM members representing the Search Service (SEIMB) according to the login process of the IM system; and
publishing the IM members representing the Search Service (SEIMB).

3. The method according to claim 1 further comprising:
presenting the search query to the IM user who inputs the search query in his or her IM window;
presenting the search query to all other IM user(s) involved in the same IM conversation session in their respective IM window(s);
presenting the search results inline in the IM window of the IM user who initiates the search; and
presenting the search results inline to all other IM user(s) involved in the same IM conversation session in their respective IM window(s).

4. The method according to claim 1 wherein the buddies or contacts representing one or more Search Services can be grouped by an IM user.

5. The method according to claim 2 wherein the IM client simulator (SEIMCS) is built according to the communication and application protocol of an IM system which may employs client-server architecture, or peer-to-peer architecture, or others.

6. The method according to claim 2 wherein the search results can be customized by the IM client simulator (SEIMCS) according to the features of the IM system.

7. The method according to claim 3 wherein the search query may be inputted in any media format supported by the IM system, for example but not limit to text based keywords, image(s), hyperlink(s), audio clip(s), video clip(s), or real-time stream, etc.

8. The method according to claim 3 wherein the presented search results may contain any media format supported by the IM system, for example but not limit to text, image(s), hyperlink(s), audio clip(s), video clip(s), or real-time stream, etc.

9. The method according to claim 3 wherein the search results may contain one or more sponsored results.

10. A system that is configured to perform search in an Instant Messaging (IM) environment, the system comprising:
an IM client software that supports buddy list or contact list;
one or more Search Services which can be represented by one or more IM members for an IM system;
the said IM client software allows the IM users to freely add the said one or more IM members representing the Search Service as buddies or contacts;
the said Search Service implements an IM client simulator (SEIMCS) according to the communication and application protocol of the said IM system;
the said Search Service defines one or more universally unique IDs (UUIDs), registers those UUIDs as the members of the said IM system, and publishes the said IM members with UUIDs;
the said Search Service runs its IM client simulator (SEIMCS) for the said IM system, and logs in the said IM members representing the said Search Service;
a standalone inline search is performed by an IM user who chooses from the buddy list or contact list of his or her IM system a buddy or contact representing a Search Service;
a shared inline search among multiple IM users involving in the same session of an IM conversation is performed by one of the IM users who chooses from the buddy list or contact list of his or her IM system a buddy or contact representing a Search Service and adds it to the said IM conversation;
wherein the search query is inputted as a regular IM message to the said IM client software by one of the IM user(s);
wherein the said IM client software transmits the said search query as a regular IM message to all other parties involved in the same session of the IM conversation, including the said buddy or contact representing the said Search Service;
wherein the said IM client simulator (SEIMCS) of the Search Service receives the search query and relays it to the Search Engine;
wherein the said Search Engine performs the required search based on the search query and transmits the search results back to the said IM client simulator (SEIMCS);
wherein the said IM client simulator (SEIMCS) of the Search Service transmits the search results to all other parties participating in the said IM conversation;

11. The system according to claim 10 further comprising:
the said IM client software presents the said search query to the IM user who inputs the said search query in his or her IM window;
the said IM client software presents the search query to all other IM user(s) participating in the same IM conversation in their respective IM window(s);
the said IM client software presents the search results inline in the IM window of the IM user who initiates the search; and
the said IM client software presents the search results inline to all other IM user(s) participating in the said IM conversation in their respective IM window(s).

12. The system according to claim 10 employs a communication protocol that allows communicating among the IM client software running on the devices of IM users. The said communication protocol may be client-server architecture, peer-to-peer architecture or other mechanism.

13. The system according to claim 10 wherein the said IM client simulator (SEIMCS) of the Search Service may customize the said search results according to the features of the said IM system.

14. The system according to claim 11 wherein the search query may be in any format supported by the IM system, for example but not limit to text based keywords, image, audio clip, video clip, real-time stream, etc.

15. The system according to claim 11 wherein the search results may be in any format supported by the IM system, for example but not limit to text, image, hyperlink(s), audio clip(s), video clip(s), real-time stream, etc.

16. The system according to claim 11 wherein the search results may contain one or more sponsored results.

17. A framework that allows multiple Search Services to be presented and used in an IM services by IM users, and a Search Service to serve multiple IM systems, wherein the Search Services and the IM services are operated independently, the framework comprising:
an IM system that allows other service providers to use its communication and application protocols;
a buddy list or a contact list of the IM client software of the said IM system, which is used to contain one or more buddies or contacts representing one or more Search Services;
a Search Service that implements one or more IM client simulators (SEIMCS) according to the communication and application protocol of the IM systems the Search Service is intended to service, respectively;
the said Search Service defines one or more universally unique identifiers (UUIDs), registers one or more IM members with the said UUIDs to one or more IM systems, and publishes the said IM members representing the Search Service; and
the said Search Service runs the said IM client simulators (SEIMCS) for one or more IM systems persistently, and logs in the said IM systems with the said IM members.

18. A computer program product for performing searches in an Instant Messaging (IM) environment, the computer program product comprising:
code for a Search Service to implement an IM client simulator (SEIMCS) according to the communication and application protocol of an IM system;
code for the said IM client simulator (SEIMCS) to customize the search results according to the features supported by the said IM system;
